(19) United States
(12) Patent Application Publication
(10) Pub. No.: US 2016/0377216 A1
(43) Pub. Date: Dec. 29, 2016

(54) A TYPE OF WATER-GUIDOMG PIPE

(71) Applicant: Jok Sun YIP, Kornhill Hong Kong (CN)

(72) Inventors: Jok Sun Yip, Kornhill Hong Kong (CN); Ching Koon Yip, Kornhill Hong Kong (CN)

(21) Appl. No.: 15/110,089

(22) PCT Filed: Dec. 10, 2014
(86) PCT No.: PCT/CN2014/093416

§ 371 Date: Sep. 12, 2016

(30) Foreign Application Priority Data
Jan. 7, 2014 (HK) 14100130.5

(51) Int. Cl. F16L 55/07; F16L 57/02

(52) U.S. Cl. CPC F16L 55/07; F16L 57/02

(57) ABSTRACT

The present invention relates to a water-guiding pipe, in particular to a water-guiding pipe into which a water-absorbing material is installed. When the position of the water-absorbing material at a water-draining end of the guiding pipe is lower than the level of a liquid surface into which the water-absorbing end of the guiding pipe is inserted. liquid drops are formed at the water-draining end of the guiding pipe and fall into a given water-receiving place. A water-guiding process is independent of the path that a middle part of the guiding pipe passes through or whether the guiding pipe is higher than a water-taking level. When it is required to prevent excessive drainage of water due to siphonage caused by the water-absorbing material filled up with water, at least a hole may be provided on a portion of the guiding pipe not in contact with water. The water-guiding pipe of the present invention may be used for occasions such as water replenishing for a stinktrap of a sanitary fitment or irrigation (including drop irrigation).

### TECHNICAL FIELD

The present invention relates to a water-guiding pipe and usage thereof, in particular to a water-guiding pipe into which a water-absorbing material is installed.

### BACKGROUND

Drain pipes in normal buildings are connected to water-discharging devices outside each unit, such as a washbasin, a shower tub, a toilet and a platform discharging outlet. Each of the above-mentioned water-discharging devices is provided with a water-collecting device, in which a stinktrap (including a U-shaped, goblet-shaped, or anti-siphonate stinktrap) is provided for preventing germs, odors and insects in the main drain pipe from entering the buildings. Thus, the stinktrap should have enough water stored therein so as to fulfill an air trapping function. However, if the drain pipes of the buildings have cracks or are damaged or the stinktrap is dried up, the drain pipes of the buildings will lose the functions of preventing waste water and odors from flowing back to the buildings, which is a source for the environmental pollution. Users of the buildings need to regularly pour clean water into all the drain outlets to prevent drying of the stinktrap. Certainly, for achieving the above effect, corresponding facilities such as an electronic pump can be used to keep pumping water from a water source to the drain outlet, or to drain the air inside a guiding pipe to achieve siphonic effect so that the water of the water source can be drawn out to the drain outlet. However, the above methods have following disadvantages: (1) electricity is supplied or consumed all the time when the corresponding facilities are used, and (2) regarding withdrawing the air inside the water guiding pipe to achieve siphonic effect, once the water level of the water source is lower than the water receiving place, the air just enters a siphon pipe, the siphonic effect terminates, and no water flows into the water outlet any more. To restore the water-guiding, the water level would arrive at or be higher than the water guiding end again, and after the air is withdrawn, the siphonic effect can restart, which is a time-consuming and arduous process. Besides, in the siphonic course the water-draining amount cannot be adjusted.

Some products on the market indeed can guide water to the stinktrap, such as the Chinese utility model patents Nos. 201320148173.9 and 201220136159.2. However, the designed water-guiding sources are provided near water-collecting devices at water-draining places in the buildings. The specific disadvantages are as follows: (1) the water source is fixed and has to be provided at a position which is higher than the water-draining place; (2) debris (such as hair) is easily accumulated at this position, which easily blocks the water source; (3) once no water is supplied for a long time, the water source will be dried, which affects actual functions of the system; and (4) if the water source has a large capacity (for example, it is placed in a toilet reservoir), the siphonage will cause excessive water diversion, which results in a waste of water.

### SUMMARY

An object of the present invention is to provide a water-guiding pipe, into which a water-absorbing material is installed. A water-absorbing end of the guiding pipe is inserted a liquid in a certain container, and the water-absorbing material delivers the liquid to a water-draining end of the guiding pipe without consuming extra energy. In addition, the water source can be placed independently. It is convenient to be used.

For achieving the above object, the present invention adopts the following technical solution: a water-guiding pipe comprises a guiding pipe, into which a water-absorbing material is installed wherein one end of the guiding pipe is a water-absorbing end, which is inserted into a container containing liquid, and the other end of the guiding pipe is a water-draining end, and the position of the water-absorbing material at the water-draining end of the guiding pipe is lower than the level of the liquid surface into which the water-absorbing end of the guiding pipe is inserted.

A water-guiding pipe comprises a guiding pipe, into which a water-absorbing material is installed wherein one end of the guiding pipe is a water-absorbing end, which is inserted into a container containing liquid, and the other end of the guiding pipe is a water-draining end. At least two water-absorbing branch pipes are provided at the water-absorbing end of the guiding pipe, each of the water-absorbing branch pipes is installed therein with the water-absorbing material, the position of the water-absorbing material at the water-draining end of the guiding pipe is lower than the level of a liquid surface into which the water-absorbing end of the guiding pipe is inserted, and the water-absorbing material can be taken out of or placed into each of the water-absorbing branch pipes.

One of the water-absorbing materials having different water absorption rates is installed into one of the water-absorbing branch pipes respectively. The water-absorbing material is flushed with or protruded from or retracted into a port of the water-absorbing end of the guiding pipe.

At least one hole may be provided on the guiding pipe, and the hole is opened on a portion of the guiding pipe not in contact with water.

The guiding pipe may be made of a soft material, a semi-rigid material or a flexible material.

The guiding pipe is in a shape of U.

The water-guiding pipe is used for replenishing water to a stinktrap of a sanitary fitment.

The water-guiding pipe is used for irrigation (including drop irrigation).

The present invention has the following advantages.

Since the guiding pipe is installed therein with the water-absorbing material, it can automatically suck water from a water source such as a container containing water without being supplied with consuming electricity. Due to the absorbability of the water-absorbing material, the guiding pipe can deliver water to a position higher than a liquid surface, and guide the water across edges of the containers or the water tanks to a position that is lower than the liquid surface from a position outside of the container. Then, liquid drops are formed at the water-draining end of the guiding pipe and fall into a given water-receiving place. Even if the water level of the water source was lower than the water-receiving place, the guiding pipe can just continue absorbing or draining water as long as the water level can arrive at or be higher than the water-receiving place again. The water can be taken out without need of opening a hole below a liquid surface of the container, also is independent of the path that the middle part of the guiding pipe passes through or whether the guiding pipe is higher than the water level of the water-getting container.

If the guiding pipe is placed into a water-collecting device, such as a reservoir (a reservoir of a toilet) that have large storage or can be replenished with water continuously, a hole or a plurality of holes can be provided on a portion of the guiding pipe not in contact with water, so as to prevent a siphonage formed due to the water-absorbing material filled up with the water, for the purpose of preventing forming the siphonage with excessive drainage of water.

If the guiding pipe takes the water from the water-collecting device having a limited storage, it is unnecessary to prevent from forming the siphonage. It is unnecessary to open holes on a portion of the guiding pipe not in contact with water. Only limited water contained in the water-collecting device is taken away, even if the water-absorbing material is filled up with water and a siphonage is created.

When using a guiding pipe made of soft material, the water-guiding pipe can be changed in its shape to facilitate passing through in accordance with specific situations of the positions the guiding pipe passes. In such a way, it has a great convenience and enlarges the range of applications. Specifically, the water-guiding process is not in limitation of the shape of the water-guiding container and the terrain and items presented along the water guiding path, which provides a great convenience and enlarges the range of applications. Different water-absorbing materials may be selected to control a water delivering rate. When using different sizes of guiding pipes, the water-absorbing rate may be controlled more easily.

Obviously, when the water-guiding pipe is used for irrigation, an obvious effect can be obtained without waste of water. The mentioned effect is more obvious when it is used for occasions such as drop irrigation. It also can be used to water the flowers at home, and in particular, it can automatically supply water when nobody at home. In addition, the water-guiding pipe of the present invention can realize irrigation (including drop irrigation) in agriculture at a relatively large scale.

### BRIEF DESCRIPTION OF THE DRAWINGS

FIG. 1 is a schematic view showing a guiding pipe according to a first embodiment of the present invention.

FIG. 2 is a schematic view showing a guiding pipe according to a second embodiment of the present invention.

FIG. 3 is a schematic view showing a guiding pipe according to a third embodiment of the present invention.

FIG. 4 is a view showing a soft guiding pipe according to a fourth embodiment of the present invention.

FIG. 5 is a schematic view showing a U-shaped pipe according to a fifth embodiment of the present invention.

### DETAILED DESCRIPTION

The present invention will be further described hereinafter in conjunction with the drawings.

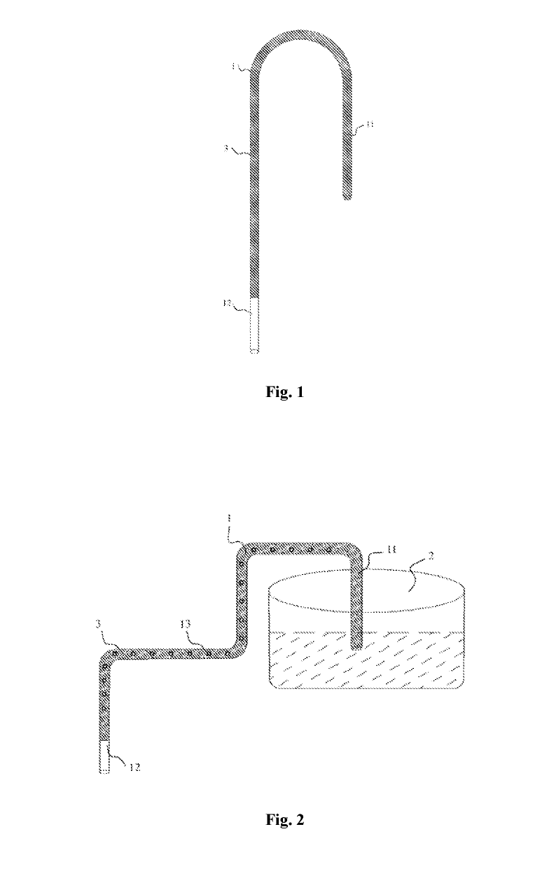

As shown in FIG. 1, in a first embodiment of the present invention, a guiding pipe 1 is installed therein with a water-absorbing material 3. One end of the guiding pipe 1 is a water-absorbing end 11, which is inserted into a container containing a liquid. For example, in the present embodiment, the liquid is water. The water-absorbing material 3 in the guiding pipe 1 is flushed with or protruded from the water-absorbing end 11 of the guiding pipe 1, and absorbs the water from the container by contacting the water. The water reaches a water-draining end 12 of the guiding pipe 1 via the water-absorbing material 3, and drops down in a form of liquid drops. For ensuring the flow rate, the position of the water-absorbing material 3 at the water-draining end should be lower than the lever of a liquid surface of a water source at the water-absorbing end 11.

As shown in FIG. 2, in a second embodiment of the present invention, for preventing a siphonage phenomenon, the guiding pipe 1 is provide thereon with at least a hole 13, which is opened on a portion of the guiding pipe not in contact with water, and enables air enter the guiding pipe 1 to prevent a siphonage caused by the water-absorbing material 3 filled up with water. A plurality of holes is provided so that unexpected blockage of the holes can be prevented.

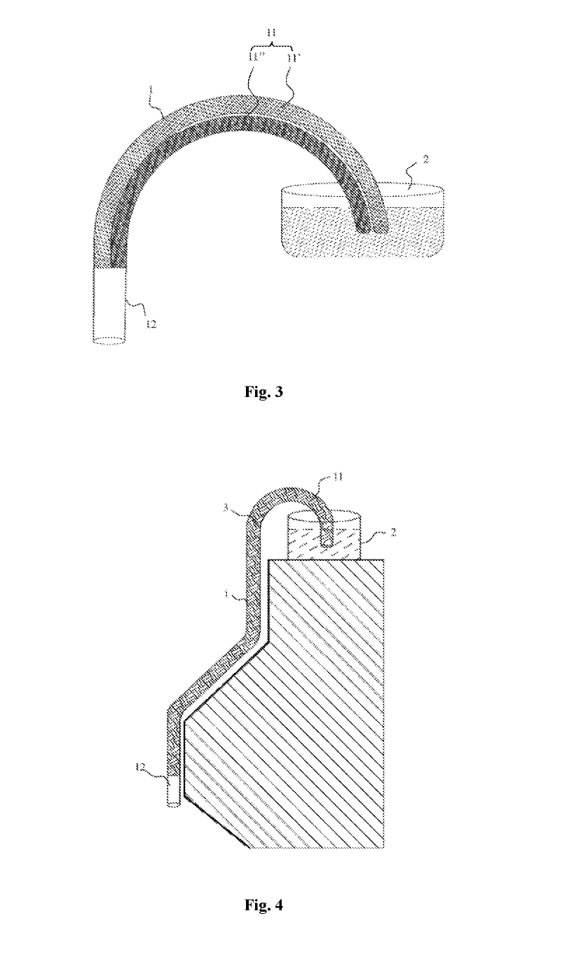

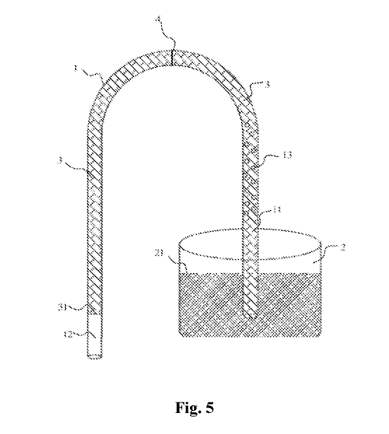

For further controlling the water-draining rate and the flow rate, the water-absorbing end of the present invention adopts a structure having multiple branch pipes. That is, two or more water-absorbing branch pipes are provided at the water-absorbing end of the guiding pipe, and each of the water-absorbing branch pipes is installed therein with the water-absorbing material. The water-absorbing material in each of the water-absorbing branch pipes may be individually installed, and the water-absorbing material can be taken out of or installed into each of the water-absorbing branch pipes. In addition, one of the water-absorbing materials having different water absorption rates may be installed into one of the water-absorbing branch pipes respectively. The water-draining end of the guiding pipe may be merged into a single pipe. The water-absorbing end of each water-absorbing branch pipe is immerged into the water source, and the water-draining rate may be adjusted by enlarging or shrinking the water-absorbing material inside the branch pipe. In a third embodiment of the present invention as shown in FIG. 3, there are two water-absorbing branch pipes. As shown in FIG. 3, a water-absorbing branch pipe 11′ and a water-absorbing branch pipe 11″ are provided at the water-absorbing end 11 of the guiding pipe 1, and the water-absorbing materials are installed into the water-absorbing branch pipe 11′ and the water-absorbing branch pipe 11″, respectively. The water-draining end 12 of the guiding pipe 1 is merged into a single pipe, and the water-absorbing materials in the water-absorbing branch pipe 11′ and the water-absorbing branch pipe 11″ can be individually taken out of or placed into. When only one water-absorbing branch pipe is operating, the water-absorbing rate is relatively low, and when two water-absorbing branch pipes are operating, the water-absorbing rate is relatively high. Likewise, for ensuring the flow rate, the position of the water-absorbing material at the water-draining end 12 should be lower than the level of the liquid surface where the water-absorbing branch pipe of the water-absorbing end 11 is immerged.

Likewise, for preventing the siphonage phenomenon which may cause waste of water, even in a case that a container 2 has a relatively large amount of water storage, at least a hole is provided on a portion of the guiding pipe not in contact with water, which enables air enter the guiding pipe so as to prevent siphonage caused by the water-absorbing material filled up with water. A plurality of the holes may be provided to prevent the holes from being unexpected blocked.

In the above embodiments, the guiding pipe 1 can be made of a soft material, a flexible material or a rigid material, which can be selected according to actual requirements. Choosing soft material or flexible material may be suitable for different home decorations. If it requires changing the shape, different requirements may be met so long as simply changing the shape of the guiding pipe 1. For example, if there are twists or slopes between the water source and the water-draining end, the water-guiding function can be realized by changing the shape of the soft guiding pipe, as long as a requirement is met that the position of the water-absorbing material at the water-draining end is lower than the level of the liquid surface of the water source.

In a fourth embodiment of the present invention as shown in FIG. 4, the guiding pipe 1 uses soft material or flexible material. In case of changing the mounting conditions, soft material may adapt to the changes of the wall body, the ground or other conditions by easily changing the shape of the guiding pipe 1.

In the situation of using the rigid or flexible materials, the shape of the guiding pipe 1 may be selected according to actual requirements. For example, in a fifth embodiment, the guiding pipe is in a shape of U, which can be hanged at any positions of the water source. In the fifth embodiment of the present invention, when hanged onto the water source, the guiding pipe 1 is in an inverted U-shape in its actual use. At this time, a length of the guiding pipe 1 from the level 21 of liquid surface to a vertex 4 of the inverted U-shape is defined as a water-guiding section, and a length from the vertex 4 of the inverted U-shape to a position 31 of the water-absorbing material at the water-draining end is defined as a water-draining section. When the position of the water-absorbing material 3 at the water-draining end 12 is lower than the level of the liquid surface of the water source at the water-absorbing end 11, the length of the water-guiding section of the guiding pipe 1 is often shorter than that of the water-draining section.

Obviously, in the above embodiments, since the position of the water-absorbing material at the water-draining end is lower than the level of the liquid surface of the water source at the water-absorbing end, and the length of the water-guiding section of the guiding pipe is often shorter than the length of the water-draining section.

For controlling the water-draining rate and amount, the diameter of the guiding pipe and the water-absorbing material may be adjusted and selected correspondingly.

The diameter of the guiding pipe should ensure the amount of the water intake and a smooth flowing of the liquid drops. The water-absorbing material may be cotton core, the sponge or other materials which can drain off water in their saturation states.

In all the above-embodiments, the water-absorbing material is flushed with or protruded from or retracted into the port at the water-absorbing end of the guiding pipe. The present invention is not merely limited to guiding the water to the stinktrap, but also can be applied to situations in which water or other liquids need to be replenished. The present invention also can be used for irrigation. It can achieve good effects in terms of watering the flowers at home (including automatically watering when nobody is at home) or using the water-guiding pipe of the present invention in agriculture to realize irrigation (including drop irrigation) at a relatively large scale.

As for the water-guiding pipe of the present invention, the above description cannot be constructed as a limitation to the protection scope of the present invention. Any modification and alteration made in accordance with the basic conceive of the present invention also should be within the scope of the present invention.

1. A water-guiding pipe, comprising a guiding pipe, into which a water-absorbing material is installed, wherein
one end of the guiding pipe is the water-absorbing end, which is inserted into a container containing liquid, and the other end of the guiding pipe is the water-draining end, and
the position of the water-absorbing material at the water-draining end of the guiding pipe is lower than the level of the liquid surface of the liquid into which the water-absorbing end of the guiding pipe is inserted.

2. The water-guiding pipe according to claim 1, wherein the water-absorbing material in the guiding pipe is flushed with, or protruded from, or retracted into the port at the water-absorbing end of the guiding pipe.

3. The water-guiding pipe according to claim 2, wherein at least one hole is set up on the guiding pipe, and the hole is opened on a portion of the guiding pipe which is not in contact with water.

4. The water-guiding pipe according to claim 1, wherein the guiding pipe is made of soft materials, rigid materials or flexible materials.

5. The water-guiding pipe according to claim 4, wherein the guiding pipe is in U-shaped.

6. A water-guiding pipe, comprising a guiding pipe into which a water-absorbing material is installed, wherein
one end of the guiding pipe is the water-absorbing end, which is in turn inserted into a container containing liquid, and the other end of the guiding pipe is the water-draining end;
at least two water-absorbing branch pipes are set up at the water-absorbing end of the guiding pipe, each of the water-absorbing branch pipes is installed with a water-absorbing material respectively, and the position of the water-absorbing material at the water-draining end of the guiding pipe is lower than the level of the liquid surface into which the water-absorbing end of the guiding pipe is inserted, and the water-absorbing material may be taken out of or placed into each of the water-absorbing branch pipes respectively.

7. The water-guiding pipe according to claim 6, wherein one of the water-absorbing materials with different water absorption rates are installed into one of the water-absorbing branch pipes respectively.

8. The water-guiding pipe according to claim 7, wherein the water-absorbing material is flushed with, or protruded from, or retracted into the port at the water-absorbing end of the guiding pipe.

9. The water-guiding pipe according to claim 6, wherein at least one hole is set up on the guiding pipe, and the hole is opened on a portion of the guiding pipe which is not in contact with water.

10. The water-guiding pipe according to claim 9, wherein the guiding pipe is made of soft material, rigid material or flexible material.

11. The water-guiding pipe according to claim 1, wherein the water-guiding pipe is used for replenishing water to a stinktrap of a sanitary fitment.

12. The water-guiding pipe according to claim 1, wherein the water-guiding pipe is used for irrigation.

13. The water-guiding pipe according to claim 2, wherein, the guiding pipe is made of soft materials, rigid materials or flexible materials.

14. The water-guiding pipe according to claim 3, wherein, the guiding pipe is made of soft materials, rigid materials or flexible materials.

15. The water-guiding pipe according to claim 13, wherein, the guiding pipe is in U-shaped.

16. The water-guiding pipe according to claim 14, wherein, the guiding pipe is in U-shaped.

17. The water-guiding pipe according to claim 7, wherein at least one hole is set up on the guiding pipe, and the hole is opened on a portion of the guiding pipe which is not in contact with water.

18. The water-guiding pipe according to claim 8, wherein at least one hole is set up on the guiding pipe, and the hole is opened on a portion of the guiding pipe which is not in contact with water.

19. The water-guiding pipe according to claim 17, wherein the guiding pipe is made of soft material, rigid material or flexible material.

20. The water-guiding pipe according to claim 18, wherein the guiding pipe is made of soft material, rigid material or flexible material.
